(19) United States
(12) Patent Application Publication
(10) Pub. No.: US 2006/0267549 A1
(43) Pub. Date: Nov. 30, 2006

(54) Charger with two types of power plugs

(76) Inventor: Ching-Hu Kung, NW Edmonton (CA)

Correspondence Address: BIRCH STEWART KOLASCH & BIRCH, PO BOX 747, FALLS CHURCH, VA, 22040-0747, US

(21) Appl. No.: 11/137,329

(22) Filed: May 26, 2005

(51) Int. Cl. H02J 7/02

(52) U.S. Cl. 320/111

(57) ABSTRACT

A charger with two types of power plugs includes a body on which an in-car power plug and an AC power plug are provided for plugging into an in-car power receptacle and an AC power receptacle, respectively, according to actual need.

### FIELD OF THE INVENTION

The present invention relates to a charger with two types of power plugs, and more particularly to a charger having both an in-car power plug and an AC power plug provided on a body thereof.

### BACKGROUND OF THE INVENTION

Please refer to FIG. 1 that is a perspective view of a first conventional charger having an AC power plug 111 provided on a body 112 thereof. The body 112 is also provided with a universal serial bus (USB) interface 111a for connecting to a USB connector 113a provided at an end of a power cord 113. Another USB connector 113b provided at the other end of the power cord 113 may be connected to a USB interface 114a on an electronic unit 114. When the electronic unit 114 is connected to the body 112 of the charger via the power cord 113 with the AC power plug 111 of the charger plugged into an AC power receptacle, the electronic unit 114 may be charged.

FIG. 2 is a perspective view of a second conventional charger having an in-car power plug 121a fixedly connected to an end of a power cord 121. The other end of the power cord 121 is a USB connector 121b for connecting to a USB interface 124a on an electronic unit 124. When the electronic unit 124 is connected to the charger via the power cord 121 with the in-car power plug 121a plugged into an in-car power receptacle, the electronic unit 124 may be charged.

The first and the second conventional charger shown in FIG. 1 and FIG. 2 are designed for connecting to an AC power receptacle and an in-car power receptacle, respectively, and are not mutually replaceable. In other words, either the first or the second conventional charger could only be plugged into a specific power receptacle corresponding to the power plug provided on the charger. A user has to purchase both types of chargers to charge an electronic unit via an in-car power receptacle or an AC power receptacle as necessary. In the case of using the electronic unit on a trip, it is very inconvenient for the user to carry two different types of chargers for charging the electronic unit via an in-car or an AC power receptacle.

It is therefore tried by the inventor to develop a charger that enables a user to charge an electronic unit via an in-car or an AC power receptacle at any time and at any place according to actual need.

### SUMMARY OF THE INVENTION

A primary object of the present invention is to provide a charger with two types of power plugs, namely, an in-car power plug and an AC power plug.

Another object of the present invention is to provide a charger that could be plugged into an in-car power receptacle or an AC power receptacle as necessary.

A further object of the present invention is to provide a charger that is convenient for use.

A still further object of the present invention is to provide a charger that can be manufactured at reduced labor and material costs.

A still further object of the present invention is to provide a charger that occupies less space.

To achieve the above and other objects, the charger according to the present invention includes a body on which an in-car power plug and an AC power plug are provided for plugging into an in-car power receptacle and an AC power receptacle, respectively, according to actual need. The body of the charger is formed with a first recess, in which the in-car power plug is movably mounted to move between a concealed position and an extended position, and a second recess, in which the AC power plug is movably mounted to move between a concealed position and an extended position.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a first conventional charger for charging an electronic unit;

FIG. 2 is a perspective view of a second conventional charger for charging an electronic unit;

FIG. 3 is a cutaway perspective view of a charger with two types of power plugs according to a first preferred embodiment of the present invention, wherein the two types of power plugs are located at a concealed position;

FIG. 3A is an enlarged view of the circled area of FIG. 3;

FIG. 4 is a perspective view of the charger of FIG. 3 with the two types of power plugs located at an extended position;

FIG. 5 shows the charger of FIG. 3 is plugged into an in-car power receptacle;

FIG. 6 shows the charger of FIG. 3 is plugged into a general AC power receptacle;

FIG. 7 is a phantom perspective view of a charger with two types of power plugs according to a second preferred embodiment of the present invention, wherein the two types of power plugs are located at a concealed position;

FIG. 8 is a phantom view of the charger of FIG. 7 with the two types of power plugs located at an extended position;

FIG. 9 shows the charger of FIG. 7 is plugged into an in-car power receptacle;

FIG. 10 shows the charger of FIG. 7 is plugged into a general AC power receptacle;

FIG. 11 is a phantom perspective view of a charger with two types of power plug according to a third preferred embodiment of the present invention, wherein the two types of power plugs are located at a concealed position;

FIG. 12 is a phantom perspective view of the charger of FIG. 11, wherein the two types of power plugs are located at an extended position;

FIG. 13 shows the charger of FIG. 11 is plugged into an in-car power receptacle; and

FIG. 14 shows the charger of FIG. 11 is plugged into a general AC power receptacle.

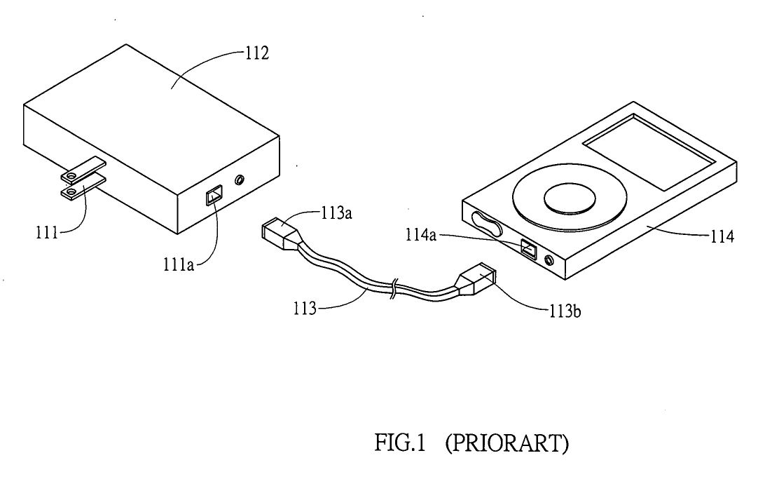

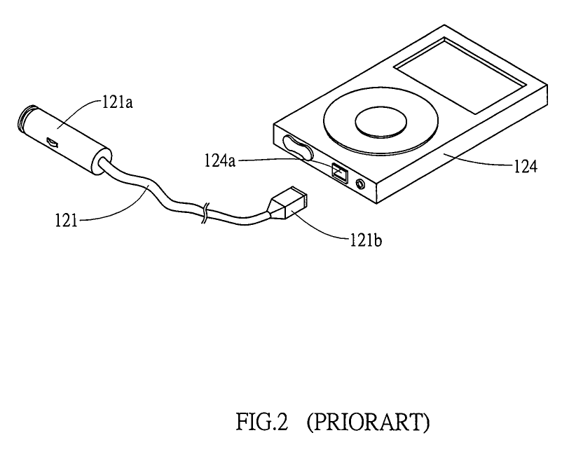

### DETAILED DESCRIPTION OF THE PREFERRED EMBODIMENTS

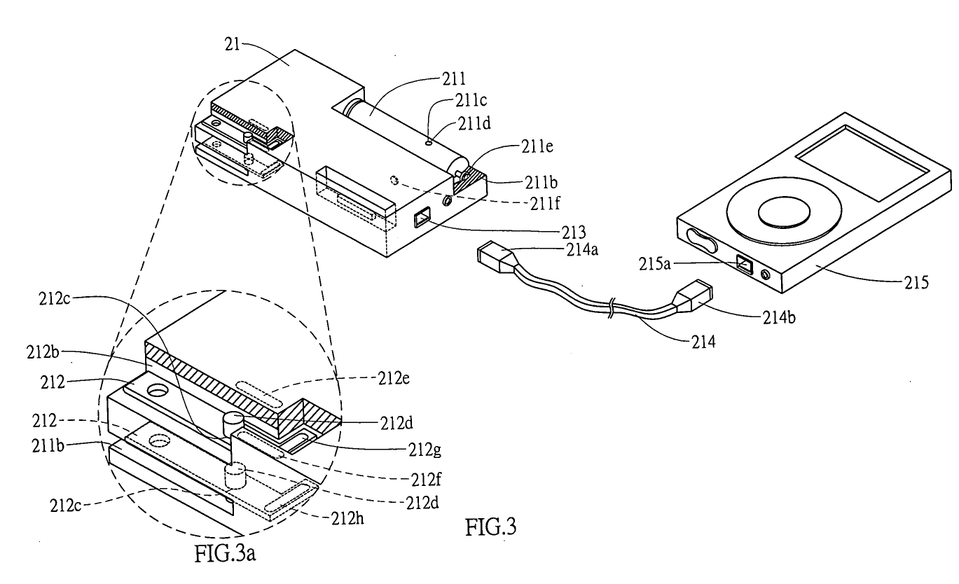

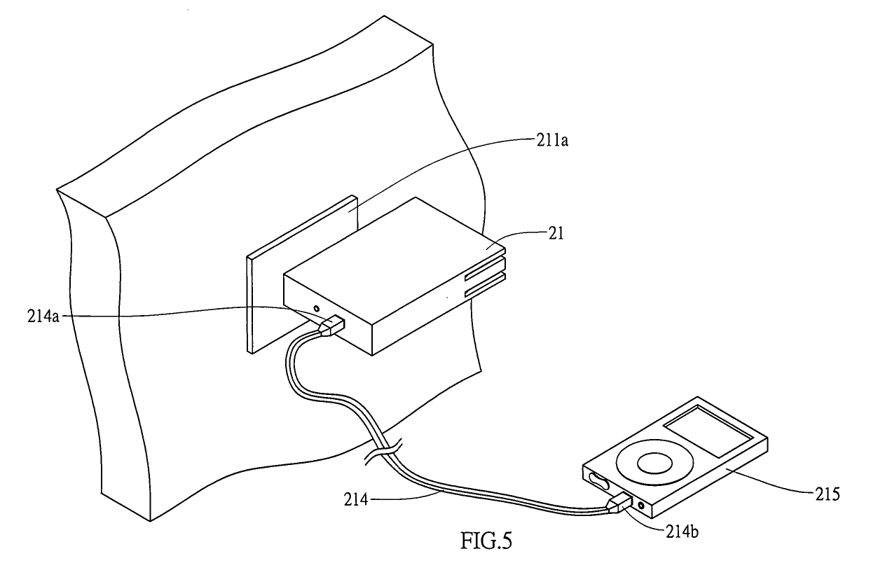

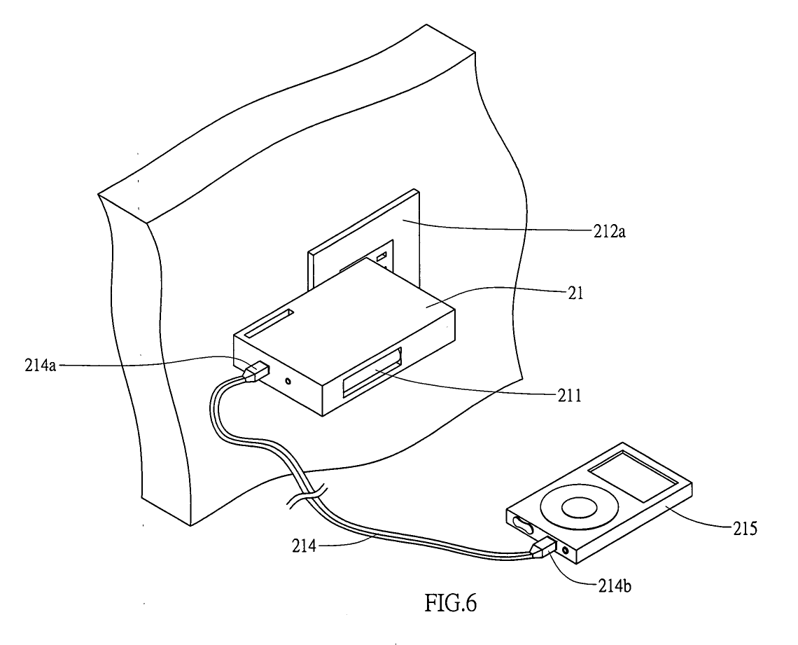

Please refer to FIG. 3 that is a cutaway perspective view of a charger with two types of power plugs according to a first preferred embodiment of the present invention. As shown, the charger includes a body 21, on which an in-car power plug 211 and a general AC power plug 212 are provided for plugging into an in-car power receptacle 211a (see FIG. 5) and a general AC power receptacle 212a (see FIG. 6), respectively, according to actual need.

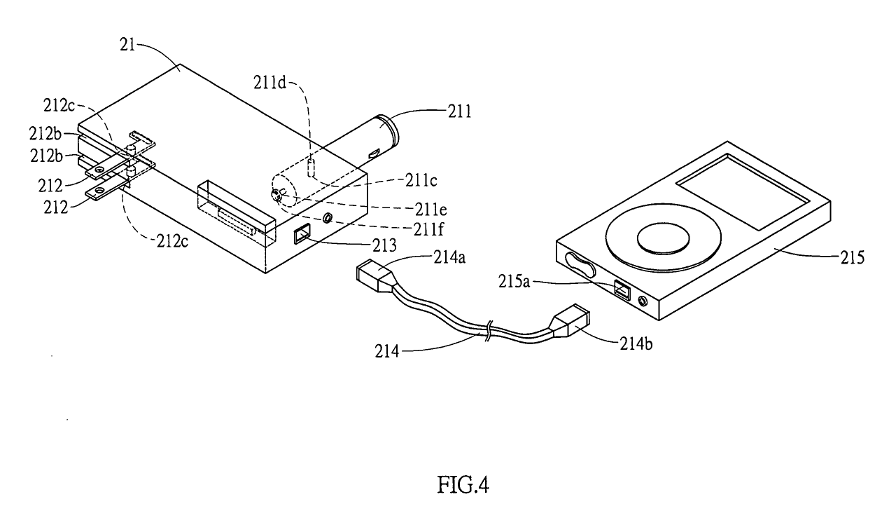

The body 21 is formed with a first recess 211b, in which the in-car power plug 211 is movably mounted. More specifically, the in-car power plug 211 is provided with a pivot socket 211c for engaging with a pivot shaft 211d in the first recess 211b, so that the in-car power plug 211 is pivotally movable between a concealed position, in which the in-car power plug 211 is fully received in the first recess 211b, as shown in FIGS. 3 and 6, and an extended position, in which the in-car power plug 211 is fully extended from the first recess 211b for plugging into an in-car power receptacle 211a, as shown in FIGS. 4 and 5.

Please refer to FIGS. 3 and 4. The in-car power plug 211 is also provided with a contact terminal 211e, which is in contact with another contact terminal 211f provided in the first recess 211b when the in-car power plug 211 is pivotally turned to the extended position.

Please refer to FIGS. 3 and 3A. The body 21 is further formed with a second recess 212b, in which the AC power plug 212 is movably mounted. More specifically, the AC power plug 212 is provided with two pivot sockets 212c for engaging with a pivot shaft 212d each in the second recess 212b, so that the AC power plug 212 is pivotally movable between a concealed position, in which the AC power plug 212 is fully received in the second recess 212b, as shown in FIGS. 3 and 5, and an extended position, in which the AC power plug 212 is fully extended from the second recess 212b for plugging into an AC power receptacle 212a, as shown in FIGS. 4 and 6.

Please refer to FIGS. 3, 3A, and 4. In the second recess 212b, there are provided with a pair of first and second contact terminals 212e, 212f, which are in contact with another pair of first and second contact terminals 212g, 212h, respectively, provided on the AC power plug 212 when the AC power plug 212 is pivotally turned to the extended position.

To use the charger with two types of power plugs according to the first embodiment of the present invention in a car, the in-car power plug 211 is pivotally turned about the mutually engaged pivot socket 211c and pivot shaft 211d to the extended position, so that the contact terminal 211e on the in-car power plug 211 is in contact with the contact terminal 211f in the first recess 211b.

Similarly, to use the charger with two types of power plugs according to the first embodiment of the present invention in a house, the AC power plug 212 is pivotally turned about the two pairs of mutually engaged pivot socket 212c and pivot shaft 212d to the extended position, so that the first and second contact terminals 212g, 212h on the AC power plug 212 are in contact with the first and second contact terminals 212e, 212f in the second recess 212b.

The body 21 of the charger is also provided with a universal serial bus (USB) interface 213 for connecting to a USB connector 214a at an end of a power cord 214. The other end of the power cord 214 is provided with another USB connector 214b for connecting to a USB interface 215a provided on an electronic unit 215. The electronic unit 215 can be easily charged when it is connected to the body 21 of the charger via the power cord 214 with the in-car power plug 211 of the charger plugged into an in-car power receptacle 211a, as shown in FIG. 5, or with the AC power plug 212 of the charger plugged into an AC power receptacle 212a, as shown in FIG. 6.

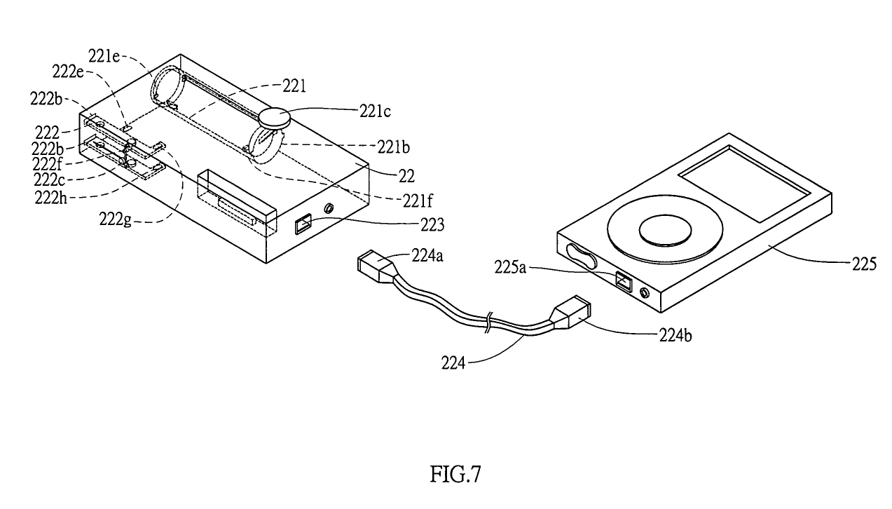

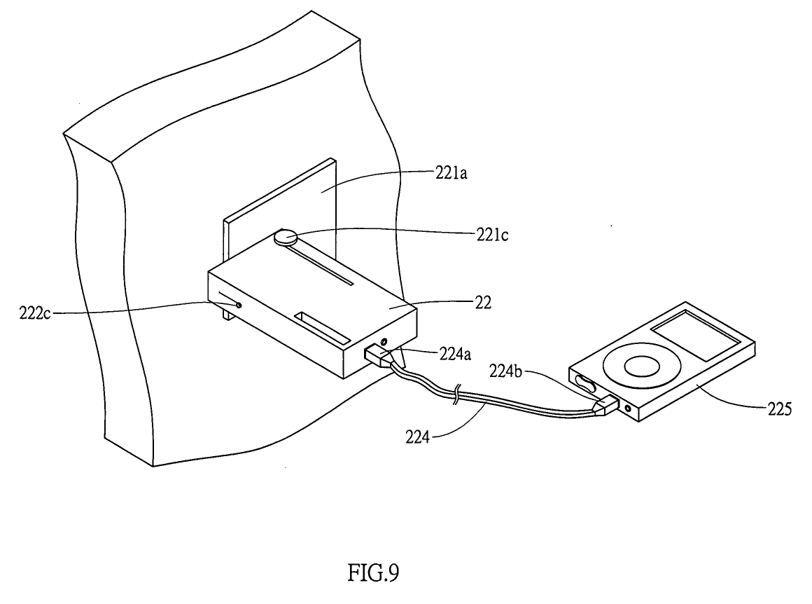

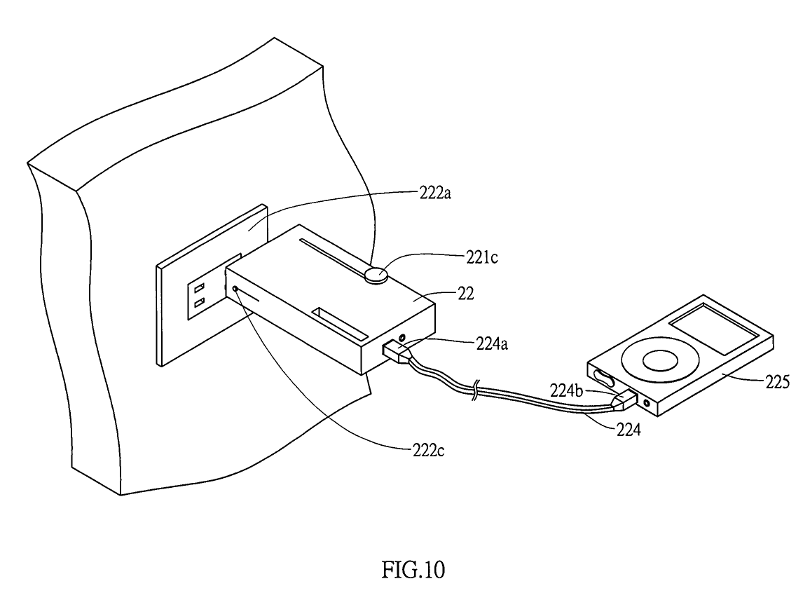

FIG. 7 is a phantom perspective view of a charger with two types of power plugs according to a second preferred embodiment of the present invention. As shown, the charger includes a body 22, on which an in-car power plug 221 and a general AC power plug 222 are provided for plugging into an in-car power receptacle 221a (see FIG. 9) and a general AC power receptacle 222a (see FIG. 10), respectively, according to actual need.

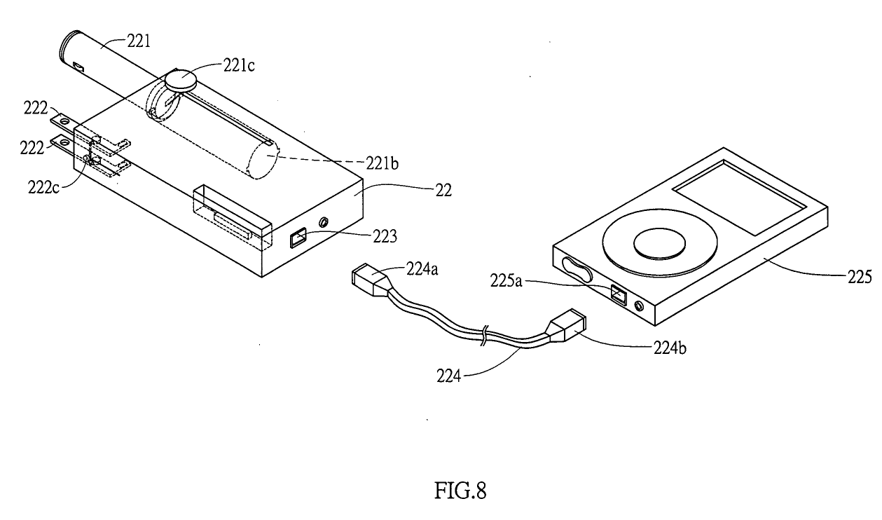

The body 22 is formed with a first recess 221b, in which the in-car power plug 221 is movably mounted. More specifically, the in-car power plug 221 is provided with an actuator 221c for axially moving the in-car power plug 221 between a concealed position, in which the in-car power plug 221 is fully received in the first recess 221b, as shown in FIGS. 7 and 10, and an extended position, in which the in-car power plug 221 is fully extended from the first recess 221b for plugging into an in-car power receptacle 221a, as shown in FIGS. 8 and 9.

Please refer to FIGS. 7 and 8. In the first recess 221b, there is provided at a predetermined position with a contact terminal 221e, which is in contact with another contact terminal 221f provided on the in-car power plug 221 when the in-car power plug 211 is moved to the extended position via the actuator 221c.

The body 22 is further formed with a second recess 222b, in which the AC power plug 222 is movably mounted. More specifically, the AC power plug 222 is provided with an actuator 222c for moving the AC power plug 222 between a concealed position, in which the AC power plug 222 is fully received in the second recess 222b, as shown in FIGS. 7 and 9, and an extended position, in which the AC power plug 222 is fully extended from the second recess 222b for plugging into an AC power receptacle 222a, as shown in FIGS. 8 and 10.

Please refer to FIGS. 7 and 8. In the second recess 222b, there are provided with a pair of first and second contact terminals 222e, 222f, which are in contact with another pair of first and second contact terminals 222g, 222h, respectively, provided on the AC power plug 222 when the AC power plug 222 is moved to the extended position via the actuator 222c.

To use the charger with two types of power plugs according to the second embodiment of the present invention in a car, the in-car power plug 221 is moved via the actuator 221c to the extended position, so that the contact terminal 221f on the in-car power plug 221 is in contact with the contact terminal 221e in the first recess 221b, as shown in FIG. 8.

Similarly, to use the charger with two types of power plugs according to the second embodiment of the present invention in a house, the AC power plug 222 is moved via the actuator 222c to the extended position, so that the first and second contact terminals 222g, 222h on the AC power plug 222 are in contact with the first and second contact terminals 222e, 222f in the second recess 222b, as shown in FIG. 8.

The body 22 of the charger is also provided with a universal serial bus (USB) interface 223 for connecting to a USB connector 224a at an end of a power cord 224. The other end of the power cord 224 is provided with another USB connector 224b for connecting to a USB interface 225a provided on an electronic unit 225. The electronic unit 225 can be easily charged when it is connected to the body 22 of the charger via the power cord 224 with the in-car power plug 221 of the charger plugged into an in-car power receptacle 221a, as shown in FIG. 9, or with the AC power plug 222 of the charger plugged into an AC power receptacle 222a, as shown in FIG. 10.

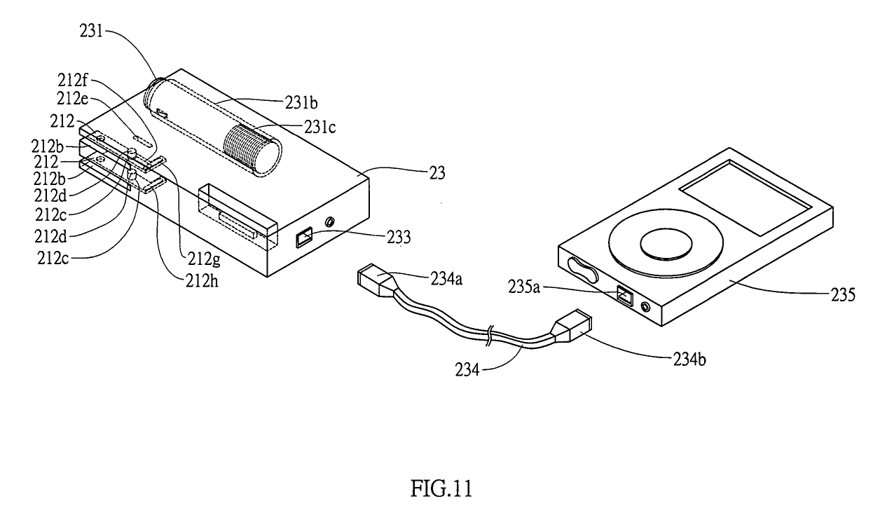

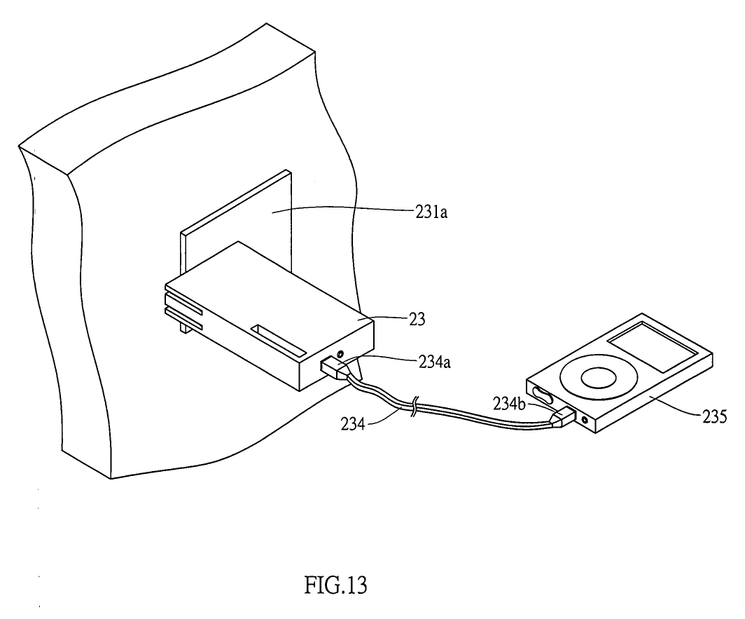

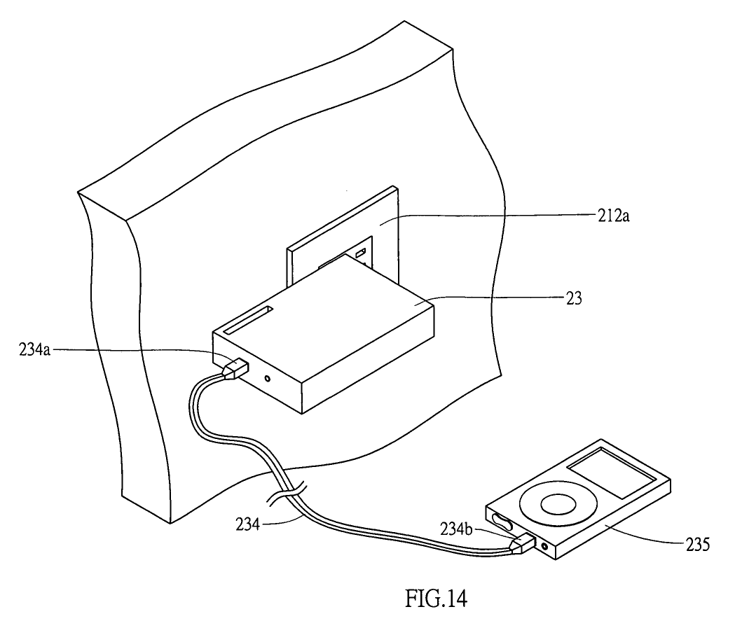

Please refer to FIG. 11 that is a phantom perspective view of a charger with two types of power plugs according to a third preferred embodiment of the present invention. As shown, the charger includes a body 23, on which an in-car power plug 231 and a general AC power plug 212 are provided for plugging into an in-car power receptacle 231a (see FIG. 13) and a general AC power receptacle 212a (see FIG. 14), respectively, according to actual need.

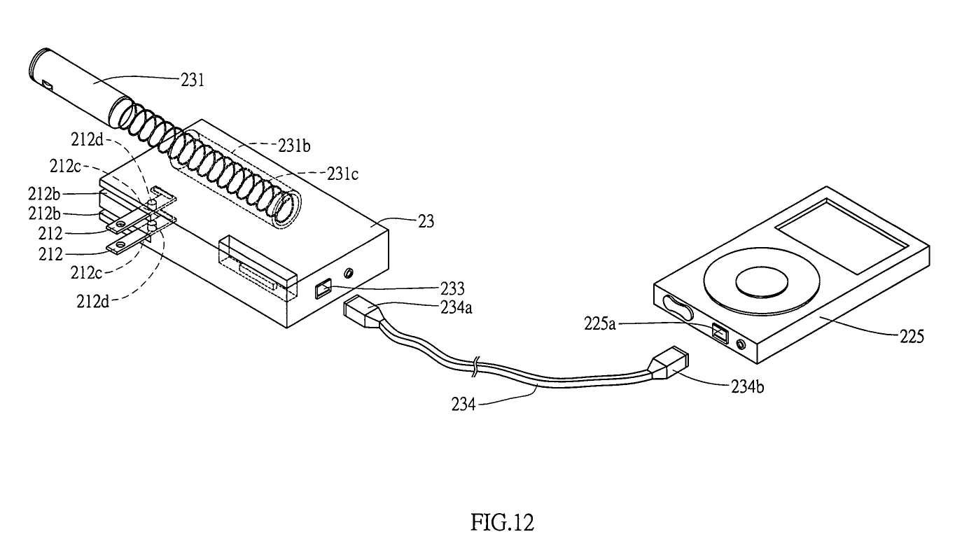

The body 23 is formed with a first recess 231b, in which the in-car power plug 231 is movably mounted. More specifically, a power cord 231c is provided in the first recess 231b to connect to and extend between the in-car power plug 231 and the body 23, so that the in-car power plug 231 is axially movable between a concealed position, in which the in-car power plug 231 is fully received in the first recess 231b, as shown in FIGS. 11 and 14, and an extended position, in which the in-car power plug 231 is fully extended from the first recess 231b for plugging into an in-car power receptacle 231a, as shown in FIGS. 12 and 13.

Please refer to FIGS. 11 and 12. The body 23 is further formed with a second recess 212b, in which the AC power plug 212 is movably mounted. More specifically, the AC power plug 212 is provided with two pivot sockets 212c for engaging with a pivot shaft 212d each in the second recess 212b, so that the AC power plug 212 is pivotally movable between a concealed position, in which the AC power plug 212 is fully received in the second recess 212b, as shown in FIGS. 11 and 13, and an extended position, in which the AC power plug 212 is fully extended from the second recess 212b for plugging into an AC power receptacle 212a, as shown in FIGS. 12 and 14.

Please refer to FIGS. 11 and 12. In the second recess 212b, there are provided with a pair of first and second contact terminals 212e, 212f, which are in contact with another pair of first and second contact terminals 212g, 212h, respectively, provided on the AC power plug 212 when the AC power plug 212 is pivotally turned to the extended position.

Please refer to FIG. 12. To use the charger with two types of power plugs according to the third embodiment of the present invention in a car, the in-car power plug 231 is axially pulled out of the first recess 231b by a predetermined distance to the extended position.

Since the power cord 231c has an overall length that is long enough for the in-car power plug 231 to slightly protrude from the first recess 231b when the power cord 231c is in a fully compressed state in the first recess 231b. When the use of the in-car power plug 231 is completed or when the in-car power plug 231 is not in use, the first recess 231b serves to receive the in-car power plug 231 and the power cord 231c therein.

Similarly, to use the charger with two types of power plugs according to the third embodiment of the present invention in a house, the AC power plug 212 is pivotally turned about the two pairs of mutually engaged pivot socket 212c and pivot shaft 212d to the extended position, so that the first and second contact terminals 212g, 212h on the AC power plug 212 are in contact with the first and second contact terminals 212e, 212f in the second recess 212b.

The body 23 of the charger is also provided with a universal serial bus (USB) interface 233 for connecting to a USB connector 234a at an end of a power cord 234. The other end of the power cord 234 is provided with another USB connector 234b for connecting to a USB interface 235a provided on an electronic unit 235. The electronic unit 235 can be easily charged when it is connected to the body 23 of the charger via the power cord 234 with the in-car power plug 231 of the charger plugged into an in-car power receptacle 231a, as shown in FIG. 13, or with the AC power plug 212 of the charger plugged into an AC power receptacle 212a, as shown in FIG. 14.

From a comparison of the present invention with the conventional chargers having only one type of power plug provided thereon, it is found the present invention is superior to the conventional chargers for the following advantages and functions:
1. The charger of the present invention has both in-car power plug 211, 221, 231 and AC power plug 212, 222 provided thereon, and can therefore be conveniently used to charge an electronic unit via either an in-car power receptacle 211a, 221a, 231a or a general AC power receptacle 212a, 222a according to actual need.
2. In the above-described three embodiments of the present invention, the in-car power plugs 211, 221, 231 and the AC power plugs 212, 222 are either pivotally turnable about engaged pivot socket and pivot shaft, or axially movable via an actuator or a power cord relative to the body 21, 22, 23 of the charger between the concealed and the extended position, such that the in-car and AC power plugs may be conveniently stored in the body when the charger is not in use, or be extended from the body when the charger is used to charge an electronic unit via an in-car or an AC power receptacle according to actual need.
3. With the in-car power plug and the AC power plug provided on the same one charger, only one power cord 214, 224, 234 is required, enabling reduction of the material cost for two power cords. Moreover, the charger with two types of power plugs can be manufactured with fewer procedures to reduce the labor cost for producing and assembling the charger.
4. Since the charger of the present invention has both the in-car power plug 211, 221, 231 and the AC power plug 212, 222 provided on the body 21, 22, 23, it has an overall volume relatively smaller than two conventional chargers having only an in-car power plug or an AC power plug, enabling a user to conveniently carry only one charger to charge an electronic unit either via an in-car power receptacle 211a, 221s, 231a or an AC power receptacle 212a, 222a according to actual need.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A charger with two types of power plugs, comprising a body on which an in-car power plug and a general AC power plug are provided for plugging into an in-car power receptacle and an AC power receptacle, respectively, according to actual need.

2. The charger with two types of power plugs as claimed in claim 1, wherein said body is formed with a first recess having a first pivot shaft provided therein, and said in-car power plug is provided with a pivot socket and pivotally mounted in said first recess with said pivot socket rotatably engaged with said pivot shaft; and said first recess having a contact terminal provided therein, said contact terminal being in contact with another contact terminal provided on said in-car power plug when said in-car power plug is pivotally turned about said engaged pivot socket and first pivot shaft to an extended position, in which said in-car power plug is projected from said body for plugging into said in-car power receptacle.

3. The charger with two types of power plugs as claimed in claim 1, wherein said body is formed with a second recess having a pair of second pivot shafts provided therein, and said AC power plug is provided with a pair of pivot sockets and pivotally mounted in said second recess with said pair of pivot sockets rotatably engaged with said pair of second pivot shafts; and said second recess having a pair of first and second contact terminals provided therein, said pair of first and second contact terminals being in contact with another pair of first and second contact terminals provided on said AC power plug when said AC power plug is pivotally turned to an extended position, in which said AC power plug is projected from said body for plugging into said AC power receptacle.

4. The charger with two types of power plugs as claimed in claim 1, wherein said body is formed with a first recess having a contact terminal provided therein, and said in-car power plug is provided with another contact terminal and movably mounted in said first recess; and said contact terminal in said first recess being in contact with said contact terminal on said in-car power plug when said in-car power plug is moved to an extended position, in which said in-car power plug is projected from said body for plugging into said in-car power receptacle.

5. The charger with two types of power plugs as claimed in claim 4, wherein said in-car power plug is provided with an actuator for moving said in-car power plug relative to said first recess on said body to said extended position.

6. The charger with two types of power plugs as claimed in claim 1, wherein said body is formed with a second recess having a pair of first and second contact terminals provided therein, and said AC power plug is provided with another pair of first and second contact terminals and movably mounted in said second recess; and said pair of first and second contact terminals in said second recess being in contact with said another pair of first and second contact terminals provided on said AC power plug when said AC power plug is moved to an extended position, in which said AC power plug is projected from said body for plugging into said AC power receptacle.

7. The charger with two types of power plugs as claimed in claim 6, wherein said AC power plug is provided with an actuator for moving said AC power plug relative to said second recess on said body to said extended position.

8. The charger with two types of power plugs as claimed in claim 1, wherein said body is formed with a first recess, and said in-car power plug is axially movably mounted in said first recess with a power cord connected to and extended between said in-car power plug and said body of said charger.
